(19) United States
(12) Patent Application Publication
(10) Pub. No.: US 2007/0257500 A1
(43) Pub. Date: Nov. 8, 2007

(54) Multi-Function Sauna

(75) Inventor: Andre L. Levesque, Grand Rapids, MI (US)

Correspondence Address: MCGARRY BAIR PC, 32 Market Ave. SW, SUITE 500, GRAND RAPIDS, MI, 49503, US

(73) Assignee: GRAND PACKAGING, LLC, Wayland, MI (US)

(21) Appl. No.: 11/465,903

(22) Filed: Aug. 21, 2006

Related U.S. Application Data
(60) Provisional application No. 60/746,214, filed on May 2, 2006.

(51) Int. Cl. B60P 3/42

(52) U.S. Cl. 296/24.33

(57) ABSTRACT

A sauna which is convertible into a storage space when not in use as a sauna. The sauna is provided with a bench that is movable between a use configuration and a stowed configuration wherein the bench in stored within the sauna. The sauna has a hanging rod that is used to run electrical wiring from one wall of the sauna to another in addition to being useable to hang items. The sauna is provided with a door that automatically ventilates the interior of the sauna. The sauna can be installed in a recreational vehicle or mobile home.

### BACKGROUND OF THE INVENTION

1. Field of the Invention

The present invention relates generally to a sauna, and more generally to a sauna having multiple-functions.

2. Description of the Related Art

Recreational vehicles (RVs) are used for brief trips as well as for extended periods of travel. Types of RVs can vary from self-propelled, such as motor homes, or pulled by a vehicle, such as a trailer. The sizes of each type of RV can vary dramatically from a small, trailer to a bus-size motor home. However, the amount of space in an RV is quite limited, resulting, with the exception of the high-end of the market, in RVs designed by heavily favoring basic and necessary functionality over luxuries. As such, much effort has been focused in the RV market to maximize the space within the RV interior by limiting the number of rooms, furniture, and appliances, and further minimizing the size of the rooms, furniture, and appliances that are included in the RV. Accordingly, closets and storage spaces are also limited in RVs due to the lack of interior space and features considered to be luxuries are not even included.

However, as more and more people use recreational vehicles for longer periods of time, their demand for luxuries have increased while the practical limitations of the RV has stayed generally consistent.

One luxury not typically found in an RV is a sauna, which is a popular means for relaxation used by many individuals. Saunas are typically not included in RV's because of the tradeoff in lost space for day-to-day functionality.

### SUMMARY OF THE INVENTION

According to the invention, an apparatus convertible between a closet and a sauna comprises a cabinet defining an interior and having an opening providing access to the interior, a heat source for selectively supplying heat to the interior, a stowable seat operable between a use configuration, where a user can sit on the seat within the interior, and a stowed configuration and a hanging rod located within the interior, whereby the apparatus can be converted from a closet to a sauna by removing items hanging on the hanging rod, placing the stowable seat in the use configuration, and selectively supplying heat to the interior with the heat source.

The hanging rod can extend between opposing sides of the cabinet. The hanging rod can define an internal raceway. The apparatus can further comprise an electrical conductor passing through the internal raceway. An electrical component can be associated with the cabinet and the electrical conductor can be electrically coupled with the electrical component. At least two electrical components can be associated with the cabinet and the electrical conductor can electrically couples the at least two electrical components. The at least two electrical components can be located on opposite sides of the cabinet. The at least two electrical components can be chosen from a group consisting of a controller, a heating element, a user interface, and a lamp.

A door can be moveably mounted to the cabinet for movement between a closed position, where the door blocks human access from an exterior of the cabinet through the opening to the interior, and an open position, where human access is permitted from the exterior through the opening to the interior, and a vent permitting the flow of air between the interior and the exterior. The vent can comprise a gap between the door and the opening when the door is in the closed position to allow air to pass between the cabinet interior and the exterior of the cabinet. At least a portion of the gap can be directly open to the interior and the exterior. The gap can extend at least partially along a side of the door, at least partially along two sides of the door, or substantially along all sides of the door. The width of the gap can be ⅛″.

The cabinet can be used as a closet by placing the stowable seat in the stowed configuration. The stowable seat can comprise a bench seat and a support, wherein the support supports the bench seat in use orientation such that a user may sit on the bench seat. The seat can be generally L-shaped, with the bench seat forming one leg of the L-shape and the support forming the other leg of the L-shape. The bench seat can be positioned against an interior wall of the cabinet in the stowed configuration. The stowable seat can be removed from the interior of the cabinet in the stowed configuration.

The apparatus can further comprise a plurality of stowable seats. The apparatus can further comprise a user interface operably coupled with the hear source for selectively controlling the supply of heat to the interior.

According to another aspect of the invention, a recreational vehicle comprising an interior living space, comprises a cabinet located within the interior living space and defining an interior and having an opening providing access to the interior, a heat source for selectively supplying heat to the interior, a stowable seat operable between a use configuration, where a user can sit on the seat within the interior, and a stowed configuration and a hanging rod located within the interior, whereby the apparatus can be converted from a closet to a sauna by removing items hanging on the hanging rod, placing the stowable seat in the use configuration, and selectively supplying heat to the interior with the heat source.

The hanging rod can extend between opposing sides of the cabinet. The hanging rod can define an internal raceway. The apparatus can further comprise an electrical conductor passing through the internal raceway. An electrical component can be associated with the cabinet and the electrical conductor can be electrically coupled with the electrical component. At least two electrical components can be associated with the cabinet and the electrical conductor can electrically couples the at least two electrical components. The at least two electrical components can be located on opposite sides of the cabinet. The at least two electrical components can be chosen from a group consisting of a controller, a heating element, a user interface, and a lamp.

A door can be moveably mounted to the cabinet for movement between a closed position, where the door blocks human access from an exterior of the cabinet through the opening to the interior, and an open position, where human access is permitted from the exterior through the opening to the interior, and a vent permitting the flow of air between the interior and the exterior. The vent can comprise a gap between the door and the opening when the door is in the closed position to allow air to pass between the cabinet interior and the exterior of the cabinet. At least a portion of the gap can be directly open to the interior and the exterior. The gap can extend at least partially along a side of the door, at least partially along two sides of the door, or substantially along all sides of the door. The width of the gap can be ⅛″.

The cabinet can be used as a closet by placing the stowable seat in the stowed configuration. The stowable seat can comprise a bench seat and a support, wherein the support supports the bench seat in use orientation such that a user may sit on the bench seat. The seat can be generally L-shaped, with the bench seat forming one leg of the L-shape and the support forming the other leg of the L-shape. The bench seat can be positioned against an interior wall of the cabinet in the stowed configuration. The stowable seat can be removed from the interior of the cabinet in the stowed configuration.

The apparatus can further comprise a plurality of stowable seats. The apparatus can further comprise a user interface operably coupled with the hear source for selectively controlling the supply of heat to the interior.

According to yet another aspect of the invention, a storage apparatus for an interior living space comprises a cabinet located within the interior living space and defining an interior and having an opening providing access to the interior, an electrical component associated with the cabinet, a hanging rod located within the interior and defining an internal raceway and an electrical conductor passing through the raceway and coupled to the electrical component.

The hanging rod can extend between opposing sides of the cabinet interior. The electrical conductor can be electrically coupled between at least two electrical components. The at least two electrical components can be chosen from a group consisting of a controller, a heating element, a user interface, and a lamp.

The hanging rod can be configured to hold a clothes hanger and the cabinet interior is configured to store clothing on a clothes hanger such that the cabinet can be used as a closet. The cabinet can comprise a heat source for selectively supplying heat to the interior. The storage apparatus can further comprise a stowable seat operable between a use configuration, where a user can sit on the seat within the interior, and a stowed configuration. The cabinet can be used as a closet by placing the stowable seat in the stowed configuration. The cabinet can be used as a sauna by removing any items hanging on the hanging rod, placing the stowable seat in the use configuration, and selectively supplying heat to the interior with the heat source.

According to still another aspect of the invention, a recreational vehicle comprising an interior living space comprises a cabinet located within the interior living space and defining an interior and having an opening providing access to the interior, an electrical component associated with the cabinet, a hanging rod located within the interior and defining an internal raceway and an electrical conductor passing through the raceway and coupled to the electrical component.

The hanging rod can extend between opposing sides of the cabinet interior. The electrical conductor can be electrically coupled between at least two electrical components. The at least two electrical components can be chosen from a group consisting of a controller, a heating element, a user interface, and a lamp.

The hanging rod can be configured to hold a clothes hanger and the cabinet interior is configured to store clothing on a clothes hanger such that the cabinet can be used as a closet. The cabinet can comprise a heat source for selectively supplying heat to the interior. The storage apparatus can further comprise a stowable seat operable between a use configuration, where a user can sit on the seat within the interior, and a stowed configuration. The cabinet can be used as a closet by placing the stowable seat in the stowed configuration. The cabinet can be used as a sauna by removing any items hanging on the hanging rod, placing the stowable seat in the use configuration, and selectively supplying heat to the interior with the heat source.

In yet another aspect of the invention, a sauna comprises a cabinet defining an interior and having an opening providing access to the interior, a heat source for selectively supplying heat to the interior, a door mounted to the cabinet and moveable between a closed position, where the door blocks human access from an exterior of the cabinet through the opening to the interior, and an open position, where human access is permitted from the exterior through the opening to the interior and a vent permitting the flow of air between the interior and the exterior and comprising a gap between the door and the opening when the door is in the closed position to allow air to pass between the cabinet interior and the exterior of the cabinet.

At least a portion of the gap can be directly open to the interior and the exterior. The gap can extend at least partially along a side of the door, at least partially along two sides of the door, or substantially along all sides of the door. The gap can have a width that effects the circulation of air between the cabinet interior and the exterior of the cabinet. The width of the gap can be ⅛″.

The sauna can further comprise at least one seat. The sauna can further comprise a user interface operably coupled with the hear source for selectively controlling the supply of heat to the interior.

In still another aspect of the invention, a method for operating a sauna cycle for a sauna comprising a cabinet defining an interior, a heat source for selectively supplying heat to the interior to maintain the interior temperature and a user interface operably coupled with the heat source for selectively controlling the operation of the heat source is disclosed. The method comprises identifying a user from a group of users and operating the heat source in response to the identified user for at least one of a pre-determined cycle time associated with the identified user and maintaining the interior temperature at a pre-determined temperature associated with the identified user.

Identifying the user can comprise a user inputting a user identification. Inputting the user identification can comprise the user selecting a user identification on the user interface.

The method can further comprise operating the heat source in response to the identified user for the other of the pre-determined cycle time associated with the identified user and the maintaining the interior temperature at a pre-determined temperature associated with the identified user. Operating the heat source in response to the identified user can comprise a user selecting a cycle time. Operating the heat source in response to the identified user can comprise the user selecting a sauna temperature.

The method can further comprise storing the cycle time and interior temperature selected by the user. The method can further comprise subsequently automatically setting the cycle time and interior temperature to the stored cycle time and interior temperature in response to the identified user. Identifying the user can comprise a user inputting a user identification. Inputting the user identification can comprise the user selecting a user identification on the user interface.

### BRIEF DESCRIPTION OF THE DRAWINGS

In the drawings:

FIG. 1 is a schematic illustration of a recreational vehicle, partially cut away to illustrate a sauna according to one embodiment of the invention.

FIG. 2 is a left perspective view of the sauna from FIG. 1.

FIG. 3 is a right perspective view of the sauna from FIG. 2, with the doors open to illustrate the interior of the sauna.

FIG. 4 is a partial left perspective view of the sauna from FIG. 2, illustrating a bench in the interior of the sauna.

FIG. 5 is a view similar to FIG. 4, illustrating the bench in a stowed configuration.

FIG. 6 is a sectional view of the sauna, taken along line 6-6 of FIG. 4.

FIG. 7 is a front view of the sauna from FIG. 2.

FIG. 8 is a close-up view of area VIII of FIG. 7.

FIG. 9 is a sectional view of a hanging rod of the sauna.

FIG. 10 is a right side perspective view of the sauna from FIG. 2, with a right side panel removed to illustrate the electrical connections of the sauna.

FIG. 11 is a left side view of the sauna from FIG. 2, with a left side panel removed to illustrate the electrical connections of the sauna.

FIG. 12 is a close-up view of a user interface for the sauna.

FIG. 13 is a flow chart illustrating a method for programming a sauna cycle.

FIG. 14 is a front view of a sauna according to a second embodiment of the present invention.

FIG. 15 is a left perspective view of the sauna from FIG. 13, with the doors open to illustrate the interior of the sauna.

FIG. 16 is a partial right perspective view of the sauna from FIG. 13, with the doors open to illustrate the interior of the sauna.

### DESCRIPTION OF THE PREFERRED EMBODIMENT

A sauna according to the present invention can be converted to a storage space when not in use as a sauna. The sauna is particularly suited from incorporation into a recreational vehicle (RV), trailer, mobile home, or houseboats where space is limited; however, the sauna can also be used in static structures such as houses, apartments, condominiums, hotels and other buildings. Therefore, while the anticipated environment for the sauna is the RV market, the invention is not so limited.

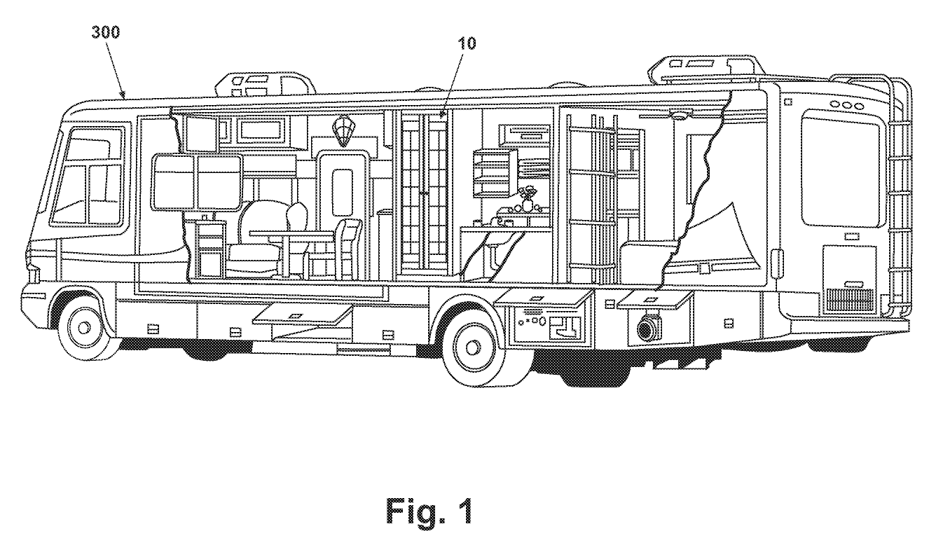

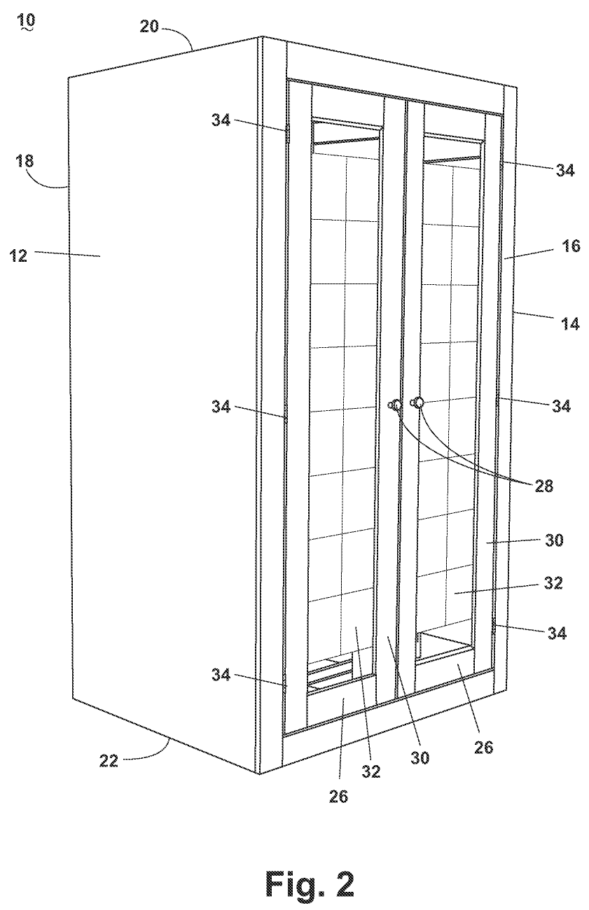

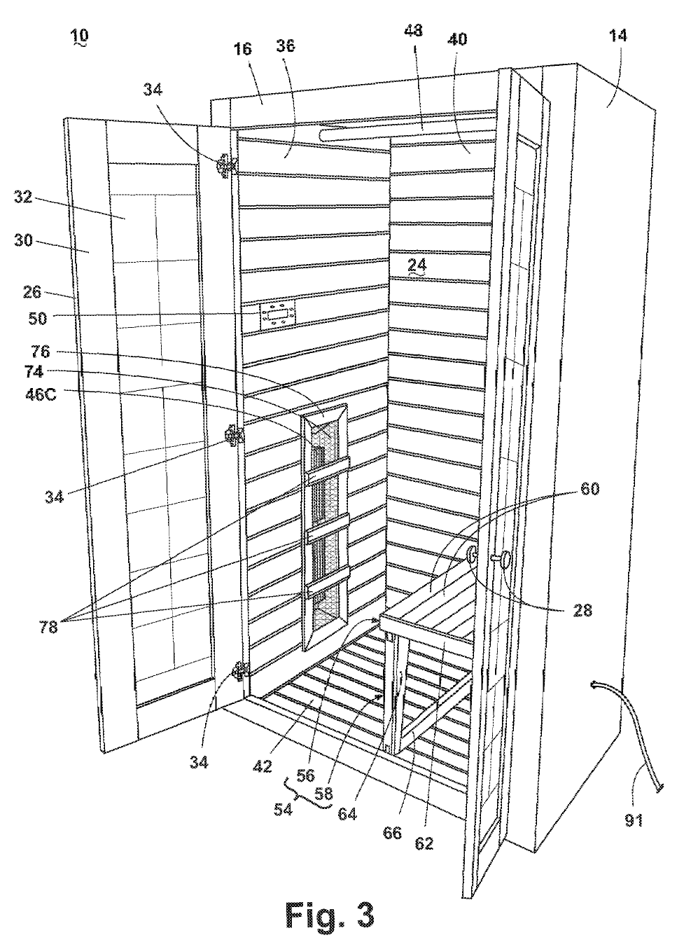

Referring now to the drawings, and in particular to FIG. 1, a first embodiment of a sauna 10 is shown installed within an RV 300. Referring to FIG. 2, the sauna 10 comprises a substantially box-like structure with spaced left and right side walls 12, 14 joined by spaced front and rear walls 16, 18, and enclosed by spaced top and bottom walls 20, 22 to define an interior space 24 (FIG. 3).

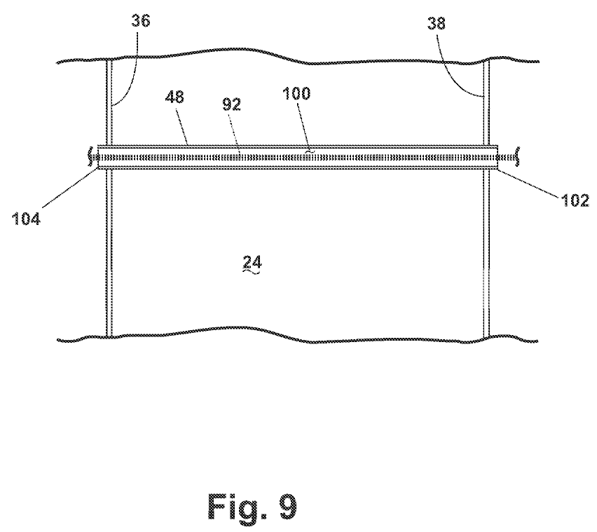

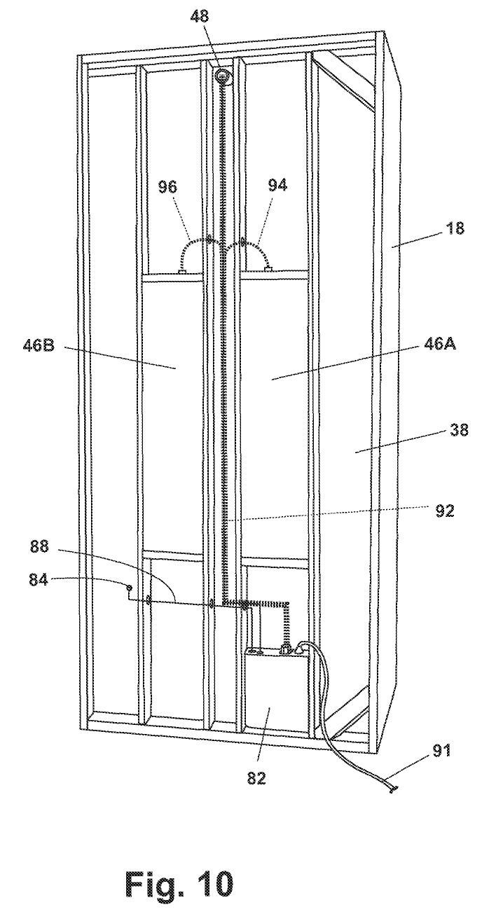

In FIG. 2, the sauna is illustrated with a trim kit, which provides a finished surface on the left and right side walls 12, 14. However, the can be an unfinished structure, as shown in FIGS. 9-10, where the left and right side walls do not include finished panels. The trim kit is used when the sauna 10 is to be free standing (i.e. not abutted by other structures on any side). However, if the sauna 10 is incorporated into an RV, one or more sides of the sauna will be abutted by other interior structure of the RV, and thus a finished appearance is unnecessary and the exterior of the sauna can be unfinished.

The front wall 16 of the sauna 10 is provided with at least one door 26 that is openable to permit entrance into the interior space 24 of the sauna 10. In the illustrated embodiment, the sauna 10 is provided with a pair of doors 26 that have handles 28 for a user to grasp to open and close the doors 26. The handles 28 can be provided on the exterior and/or interior of the doors 26. The walls 12-22 of the sauna 10 are preferably made of wood. The doors 26 preferably comprise a wooden frame 30 supporting a tempered glass panel 32. The glass panel 32 can optionally be frosted and/or etched with a pattern or design. The doors 26 are attached to the front wall 16 by hinges 34 and open outwardly to permit the user to enter or access the interior space 24. When not in operation as a sauna, the interior space 24 can be used as a storage space similar to a closet.

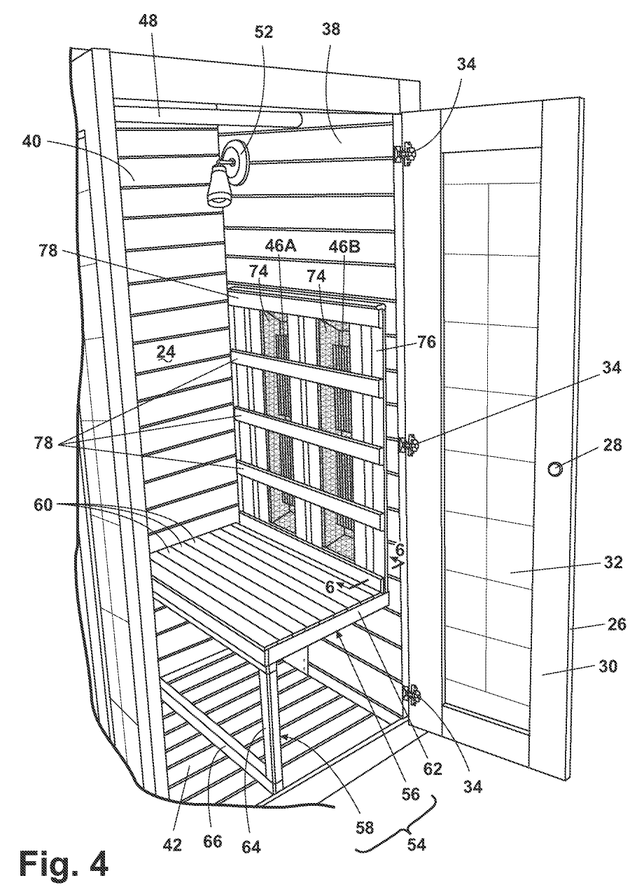

Referring to FIGS. 3-4, the interior space 24 comprises left, right, and rear interior sides 36, 38, 40, respectively, a floor panel 42 and a ceiling panel (not shown) that are preferably covered with or constructed of multiple slats of unfinished wood, such as birch cedar, redwood, hemlock, aspen and white spruce. The interior space further comprises one or more heating elements 46A-C, a hanging rod 48, a user interface 50, a lamp 52, and a removable bench 54.

The lamp 52 can be adjustable to direct light to a desired location. The lamp 52 can also be provided with a dimming function so that the magnitude of illumination can be set at a desired level. The lamp can be located on the same interior side as the bench 54 so that most of the light is directed near the user.

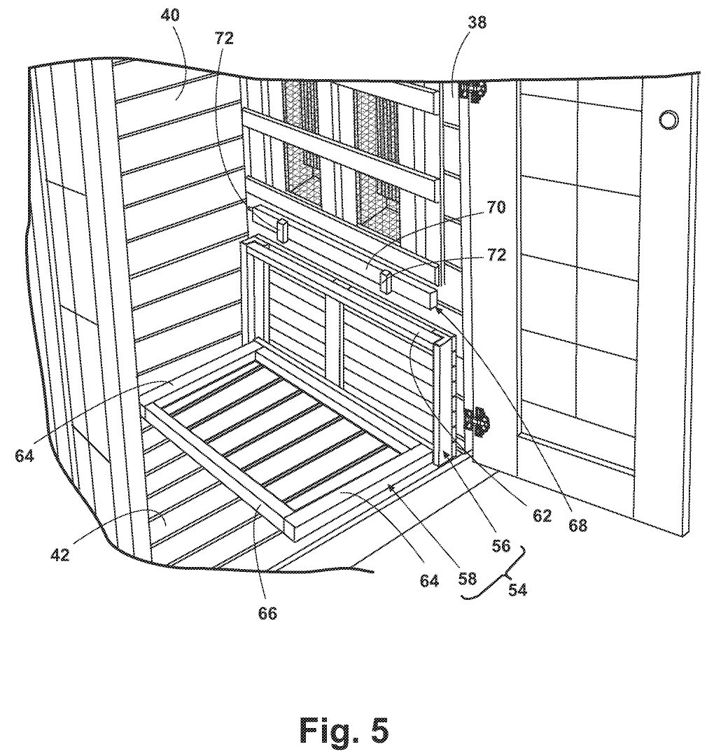

The bench 54 comprises a bench seat 56 and one or more legs 58. The bench seat 56 has an upper surface comprised of slats 60 of unfinished soft wood attached to a frame 62 that is substantially rectangular in shape. The leg 58 is U-shaped, and comprises a pair of vertical portions 64 (only one vertical portion is visible in FIG. 4) that are attached at one end to the bench seat 56 and at the other end are joined by a horizontal portion 66 that rests on the floor panel 42. The bench seat 56 and the leg 58 together form a generally L-shaped profile for the bench 54. The bench 54 is removable from a use configuration illustrated in FIG. 4, and can be stowed as illustrated in FIG. 5 when the sauna 10 is used as a storage space.

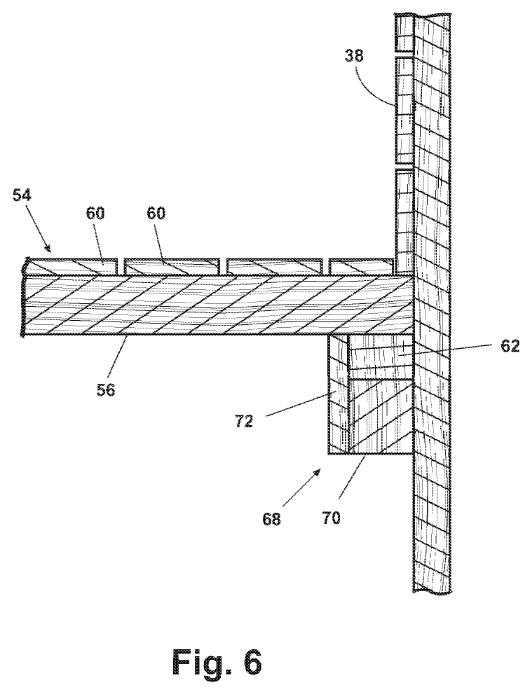

Referring to FIG. 6 in the use configuration, the bench 54 rests on a bench support 68 attached to one the right interior side 38. The bench support 68 comprises a substantially horizontal brace 70 and at least one catch 72 extending vertically and upwardly from the front of the brace 70. The rear side of the bench frame 62 fits over the catches 72 so that the frame 62 rests on the brace 70, between the catches 72 and the right interior side 38. To move the bench 54 from the use configuration to the stowed configuration, the bench 54 is lifted upwardly until the frame 62 clears the catch 72. The bench 54 is then flipped over and stowed in the sauna 10 with the bench seat 56 against the right interior side 38 and leg 58 against the floor panel 42 as illustrated in FIG. 5, or vice versa. The bench 54 can also be stowed outside the sauna 10. The sauna 10 can further be used as a storage space without moving the bench 54 to the stowed configuration.

While the bench 54 is illustrated as being completely detachable from the sauna for stowing purposes, it is within the scope of the invention for the bench 54 to remain attached to the interior side 38 while in the stowed configuration. For example, the bench seat 54 can be pivotally attached to an interior side and the leg 58 pivotally to the seat 54 such that the bench is collapsed against an interior side in the stowed configuration.

Referring again to FIGS. 3-4, the heating elements 46A-C are provided to heat the interior space 24 and/or the sauna user can be an infrared heater unit, as is known in the dry sauna art, that emit far infrared ray radiation. In the illustrated embodiment, two heating elements 46A, 46B are provided in the right interior side 38 behind the bench 54 and a third heating element 46C is provided on the left interior side 36 opposite the bench 54. The heating elements 46A-C may alternately be placed in other locations within the interior space 24. The heating elements 46A-C are recessed in the interior sides 36, 38 and emit radiation inwardly toward the interior space 24.

The heating elements 46 are covered by mesh screens 74, which prevent direct contact with the infrared unit. The mesh of the screen 74 is sized to prevent even small children from inserting their fingers through the screen 74 and directly contacting the infrared heating elements. The screens 74 can be partially covered by a wooden frame 76 crossed by generally horizontal slats 78 attached to the frame 76 to reduce or minimize direct contact between the user and the screen 74 that might otherwise deform or deflect the screen 74. The slats 78 on the screens 74 behind the bench 54 further functions as a backrest for the user when seated on the bench 54.

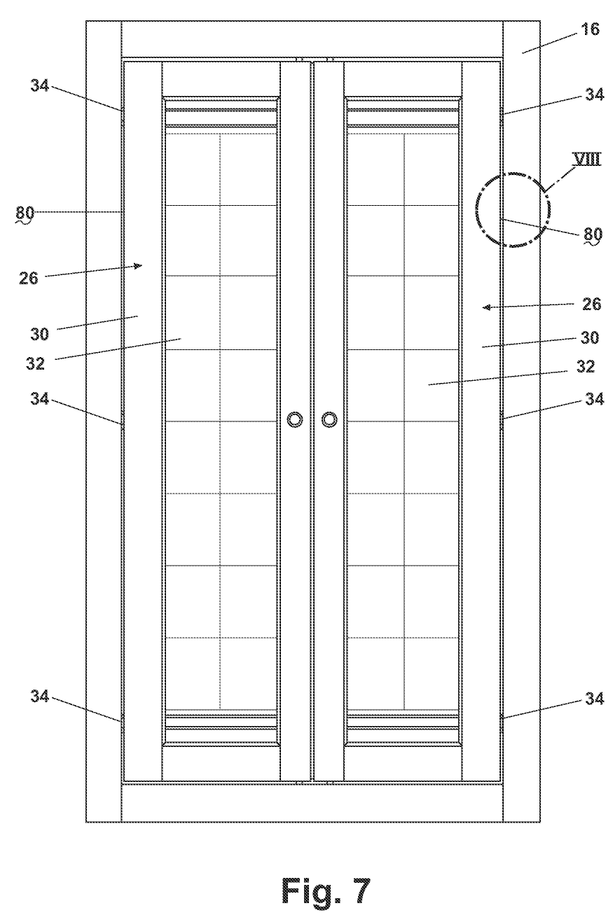

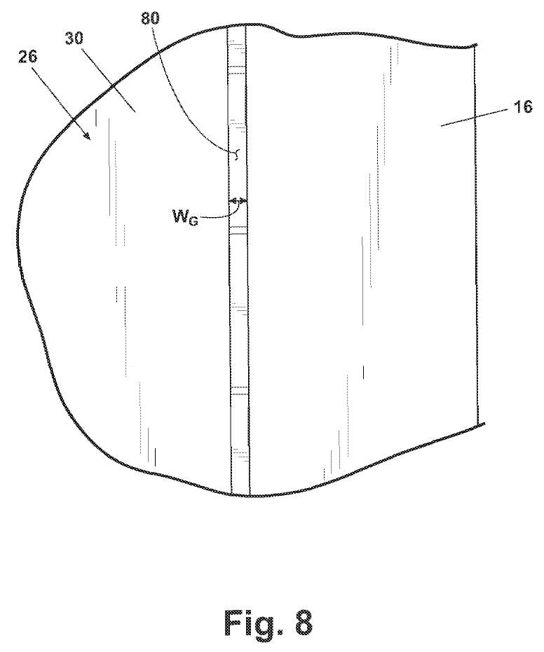

The sauna 10 is provided with means to automatically vent the interior space 24. Referring to FIGS. 7-8, an air gap 80 is provided between the front wall 16 and the door 26 that allows air to circulate between the interior space 24 and the exterior of the sauna 10 by drawing cooler air from the exterior of the sauna into the interior space 24 and exhausting hotter air from the interior space 24 to the exterior of the sauna. Preferably, the gap 80 is constructed so that at least a portion of the gap 80 is directly open to the interior space 24 and to the exterior of the sauna. The gap 80 preferably extends at least partially along the length of the hinged edge of the door frame 30, but may also extend at least partially along the top and bottom edges of the door frame 30 or substantially around the entire edge of the door 26. The gap 80 can have any width W_{G} that effects the automatic venting of the interior space 24. A non-limiting example of a suitable gap width W_{G} is ⅛″.

Referring to FIG. 9, the hanging rod 48 is attached within the interior space 24 and extends between left and right interior sides 36, 38, and has an internal raceway 100 with a first open end 102 and a second open end 104. The hanging rod 48 serves as a support for hanging items when the sauna 10 is used as a storage space or closet. The internal raceway 100 functions as a wiring conduit to permit the necessary wiring of the electronics for the sauna by receiving electrical conductors coupled to at least one electrical component associated with the sauna 10. For example, a wiring bundle 92 comprising electrical conductors such as the electrical wiring components and/or data communication components of the sauna 10 can be passed from one interior side of the sauna to the other through the internal raceway 100 of hanging rod 48.

Referring to FIG. 10, the sauna 10 comprises a controller 82 that is operably connected to the heating elements 46A-C, the user interface 50 and at least one temperature sensor 84. The controller 82 can be located in or behind the right interior side 38. A first cable 88 is coupled between the controller 82 and temperature sensor 84. The temperature sensor 84 is in communication with the interior space 24 and detect the temperature of the interior space 24. The temperature sensor 84 generate a signal indicative of the detected temperature of the interior space 24 which is received by the controller 82. A power cord 91 is coupled between the controller 82 and a power source (not shown) to supply power to the sauna. If the sauna 10 is incorporated into an RV, the power source can be the vehicle batteries or a generator. A second cable 90 is coupled between the controller 82 and the user interface 50. A wiring bundle 92 is coupled between the controller 82 and the heating elements 46A-C. The bundle of cables 92 includes branches for each heating element 46A-C and for the user interface 50. In this embodiment, there are three cable branches 94, 96, 98 for the three heating elements 46A-C and one branch 90 for the user interface 50. The first and second cable branches 94, 96 are coupled to heating elements 46A, 46B, which are located on same side of the sauna 10 as the controller 82, and thus are easily connected.

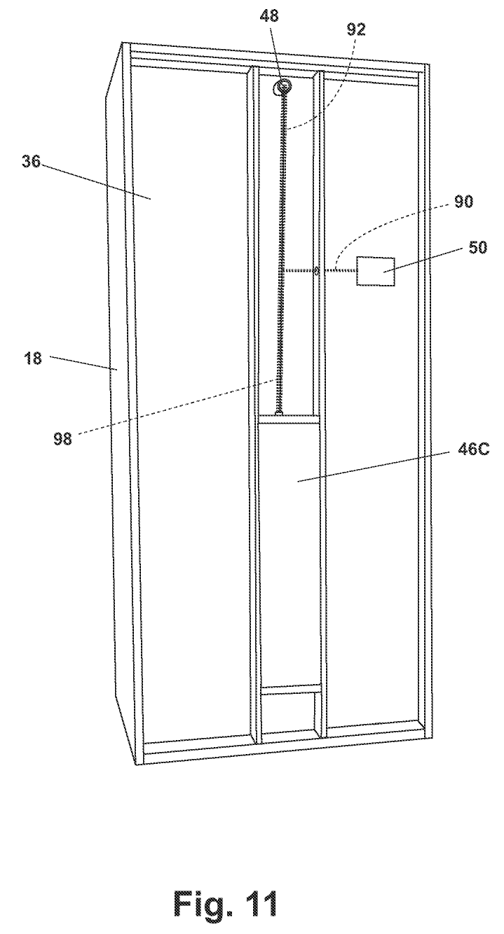

Referring to FIG. 11, the user interface 50 and heating element 46C are located on the opposite side of the sauna 10 from the controller 82. Accordingly, the wiring bundle 92 can be threaded through the hanging rod 48 to run the wiring bundle 92 from the controller 82 to the heating element 46C and user interface 50. The wiring bundle 92 is inserted into the first open end 102 from the right interior side 38, through the internal raceway 100 and out of the second open end 104 to the left interior side 36 for connection of the cable branch 98 to the heating element 46C. The internal raceway 100 of the hanging rod 48 can be used to electrically couple components of the sauna 10 that are located on different walls 12, 14, 16, 18 of the sauna 10. Most conveniently, when electrical components of the sauna 10, such as the heating elements 46A, 46B, 46C, user interface 50, lamp 52, and controller 82, are located on opposite side walls, such as on the side walls 12, 14, any necessary electrical wiring for the components can be passed through the internal raceway 100.

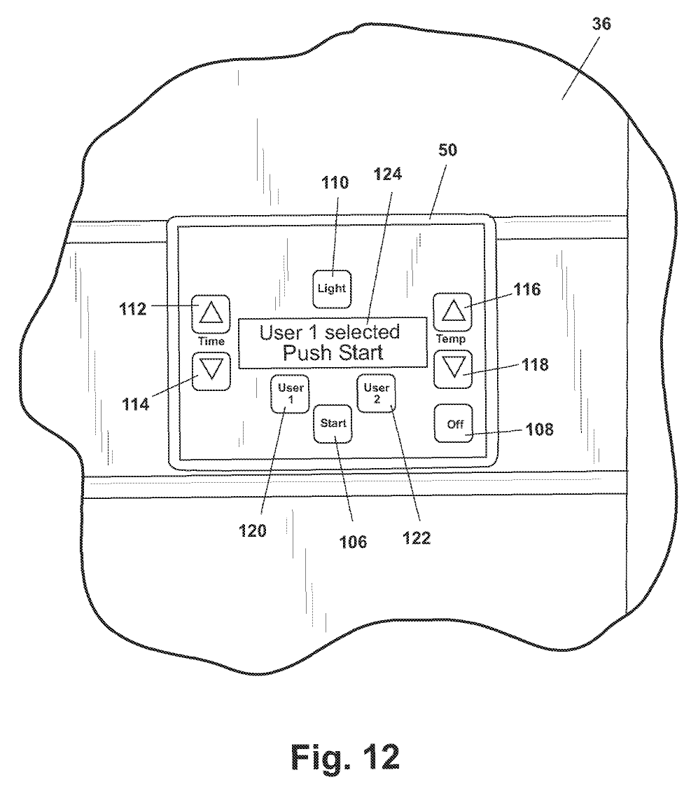

A suitable user interface 50 is illustrated in FIG. 12, where the user interface 50 is provided with a START button 106 that initiates a sauna cycle, an OFF button 108 that turns off the sauna 10 (i.e. the heating elements 46A-C), a LIGHT button 110 that turns the lamp 52 on and off, a TIME INCREASE button 112 that increases the length of the sauna cycle, a TIME DECREASE button 114 that decreases the length of the sauna cycle, a TEMPERATURE INCREASE button 116 that increase the temperature of the sauna, and a TEMPERATURE DECREASE button 118 that decreases the temperature of the sauna. The TIME INCREASE button 112 and TIME DECREASE button 114 can respectively increase and decrease the sauna cycle time in predetermined increments, for example, in one minute increments. Likewise, the TEMPERATURE INCREASE button 116 and TEMPERATURE DECREASE button 118 can respectively increase and decrease the temperature of the sauna in predetermined increments, for example, in 1° F. or 5° F. increments. The user interface 50 is operably coupled with the controller 82 which receives signals from the user interface 50 and operates the heating elements 46A-C and lamp 52 in response to the signals. The user interface 50 is preferably located on an interior side of the sauna 10, for example the left interior side 36, but can also be located on the exterior of the sauna 10.

The user interface 50 can further be used to input a sauna cycle program for a specific user. The user interface 50 can be provided with a “one-touch” button that would automatically initiate a preprogrammed sauna cycle. For the case where a group users have access to the sauna, where a group consists of at least two users, multiple one-touch buttons can be provided and each can be associated with an specific user and can additionally be used to identify a user, and consequently a preprogrammed sauna cycle for that user, to the sauna controller. For example, for a group of two users, the user interface 50 can be provided with a USER 1 button 120 that initiates a first programmed sauna cycle and a USER 2 button 122 that initiates a second programmed sauna cycle. The user interface 50 is further provided with a display 124 that optionally shows information such as user information, sauna temperature, time remaining in the sauna cycle, etc.

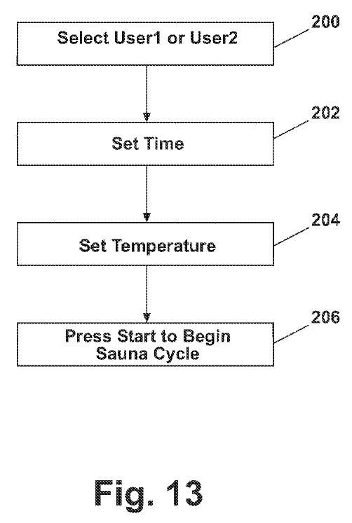

Referring to FIG. 13, a method for operating a sauna cycle for a specific user is illustrated. Initially in step 200, the user selects the USER 1 button 120 or the USER 2 button 122 to input a respective first or second user program for a sauna cycle. For example, the user presses the USER 1 button 120 to input a first user program for a sauna cycle. The initial default value for the cycle time is zero minutes and the default value for the sauna temperature is 100 OF. Other default values can be used and are not limiting on the invention. After the selection of USER 1, in step 202 the sauna cycle time is adjusted relative to the initial default valve by using the TIME INCREASE button 112 and/or TIME DECREASE button 114 to increase or decrease the time in the pre-determined increment. In step 204, the sauna temperature is adjusted relative to the initial default valve by using the TEMPERATURE INCREASE button 116 and/or TEMPERATURE DECREASE button 118 to increase or decrease the temperature in the pre-determined increment. Once the user has adjusted the cycle time and sauna temperature as desired, the START button is pressed in step 206 to initiate the cycle. If the adjusted values for the cycle time and sauna temperature are different from the previous default values, the adjusted values become the new default values. In this way the controller “remembers” the preference for a specific user. During subsequent use of the sauna, the user can simply press the USER 1 button 120 to identify himself or herself from a group of users and the START button 106 to run the programmed sauna cycle at the new default values. Additionally, a new sauna cycle can be programmed for the USER 1 button by pressing and holding the USER 1 button for the predetermined length of time, such as 5 seconds. The display 124 can show prompts and/or commands to the user in accordance with the steps of the programming method.

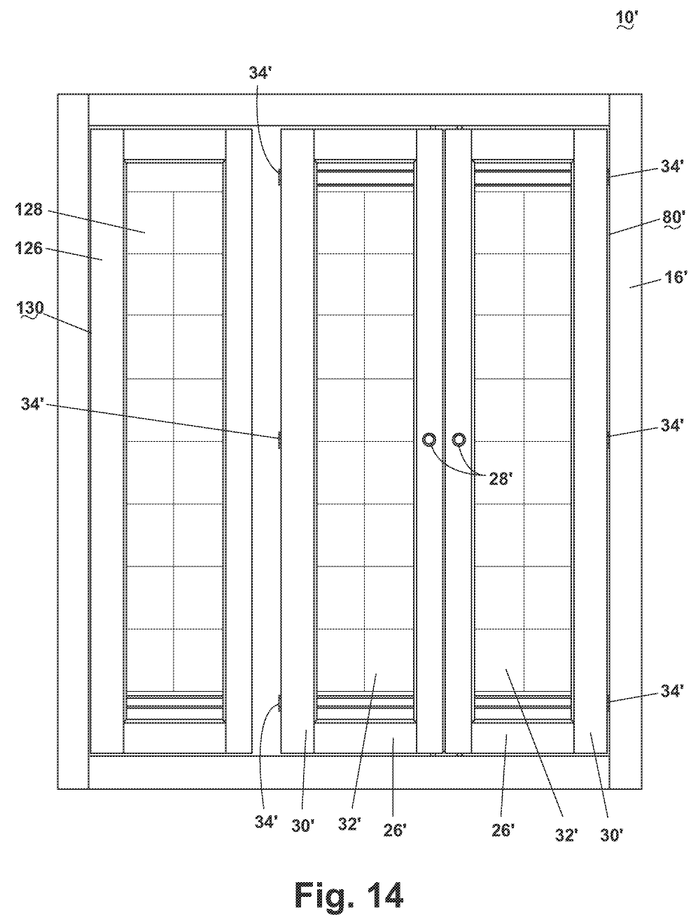

The sauna 10 can be occupied comfortably by one user at a time. A second embodiment of a sauna 10′ according to the present invention is illustrated in FIGS. 14-16, where like elements are identified by the same reference numeral bearing a prime (′) symbol. Referring to FIG. 14, the sauna 10′ can be occupied comfortably by two users at a time and comprises wider front and rear walls 16′, 18′ than sauna 10 to accommodate an additional user. The sauna 10′ can have doors 26′ that have the same dimensions as the doors 26 used for sauna 10 and is accordingly provided with an immobile frame 126 supporting a tempered glass panel 128 to cover the wider front wall 16′. The sauna 10′ can be provided with an air gap 130 between the frame 126 and front wall 16′ in addition to the air gap 80′ provided between door 26′ and the front wall 16′. The air gap 130 is generally similar to the air gap 80′.

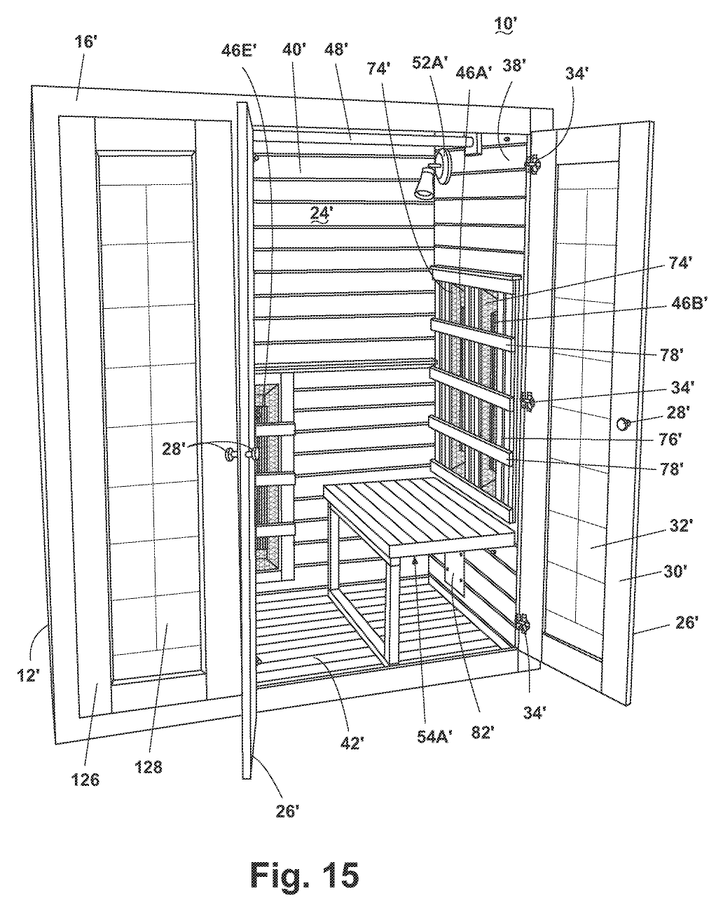

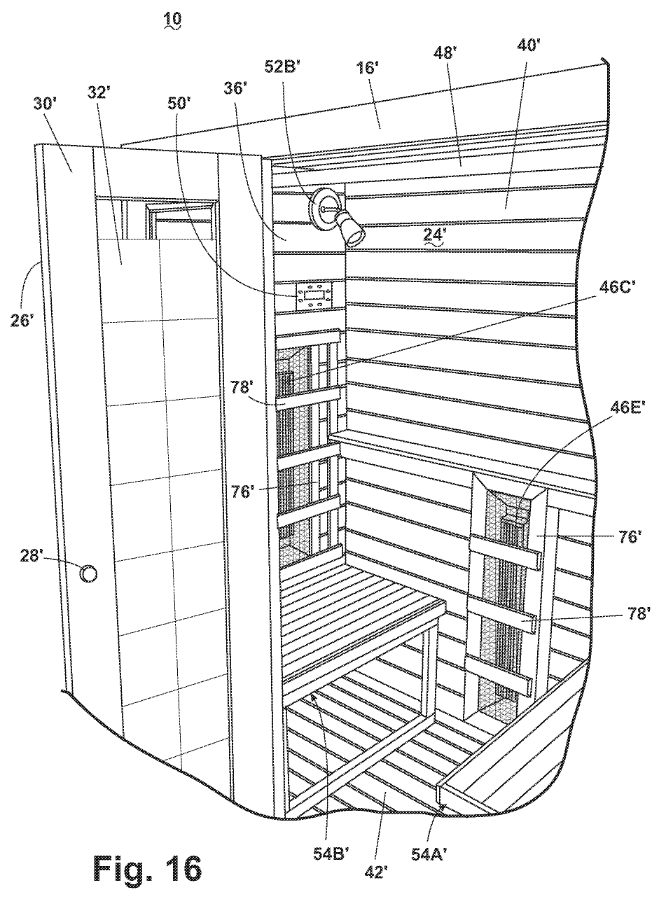

Referring to FIGS. 15-16, the sauna 10′ is provided with two benches 54A′, 54B′ to accommodate two users. A first pair of heating elements 46A′, 46B′ are provided in the right interior side 38′ behind bench 54A′ and a second pair of heating elements 46C′ (only one is visible in FIG. 16) are provided in the left interior side 36′ behind bench 54B′. A fifth heating element 46e′ is provided in the rear interior side 40′. The benches 54A′, 54B′ can be independently stowed, as described above for bench 54. Two lamps 52A, 52B are provided above each bench 54A′, 54B′, respectively, that can be operated through the user interface 50′.

The sauna 10, 10′ can be installed into any building or structure, but has particular application to the RV/mobile home market. The dual function of the sauna 10, 10′ as either a conventional sauna or a storage space make the inventive sauna particularly suited to environments where space is limited, such as an RV, but is also well-suited for installation in trailers, mobile homes, houseboats, houses, apartments, condominiums, and hotels. The stowable bench allows more of the interior space to be available for storage purposes. The hanging rod functions to hang items for storage and also to easily and efficiently run electrical wiring and cables from one side of the sauna to the other. The user interface allows for a sauna cycle to be programmed and stored for multiple users.

While the invention has been specifically described in connection with certain specific embodiments thereof, it is to be understood that this is by way of illustration and not of limitation, and the scope of the appended claims should be construed as broadly as the prior art will permit.

What is claimed is:

1. An apparatus convertible between a closet and a sauna, comprising:
a cabinet defining an interior and having an opening providing access to the interior;
a heat source for selectively supplying heat to the interior;
a stowable seat operable between a use configuration, where a user can sit on the seat within the interior, and a stowed configuration; and
a hanging rod located within the interior;
whereby the apparatus can be converted from a closet to a sauna by removing items hanging on the hanging rod, placing the stowable seat in the use configuration, and selectively supplying heat to the interior with the heat source.

2. The apparatus according to claim 1 wherein the hanging rod extends between opposing sides of the cabinet.

3. The apparatus according to claim 2 wherein the hanging rod defines an internal raceway.

4. The apparatus according to claim 3 further comprising an electrical conductor passing through the internal raceway.

5. The apparatus according to claim 4 further comprising an electrical component associated with the cabinet and the electrical conductor is electrically coupled with the electrical component.

6. The apparatus according to claim 5 further comprising at least two electrical components associated with the cabinet and the electrical conductor electrically couples the at least two electrical components.

7. The apparatus according to claim 6 wherein the at least two electrical components are located on opposite sides of the cabinet.

8. The apparatus according to claim 7 wherein the at least two electrical components are chosen from a group consisting of a controller, a heating element, a user interface, and a lamp.

9. The apparatus according to claim 1, and further comprising a door moveably mounted to the cabinet for movement between a closed position, where the door blocks human access from an exterior of the cabinet through the opening to the interior, and an open position, where human access is permitted from the exterior through the opening to the interior, and a vent permitting the flow of air between the interior and the exterior.

10. The apparatus according to claim 9, wherein the vent comprises a gap between the door and the opening when the door is in the closed position to allow air to pass between the cabinet interior and the exterior of the cabinet.

11. The apparatus according to claim 10 wherein at least a portion of the gap is directly open to the interior and the exterior.

12. The apparatus according to claim 11 wherein the gap extends at least partially along a side of the door.

13. The apparatus according to claim 12 wherein the gap extends at least partially along two sides of the door.

14. The apparatus according to claim 13 wherein the gap extends substantially along all sides of the door.

15. The apparatus according to claim 11 wherein the width of the gap is ⅛″.

16. The apparatus according to claim 1 wherein the cabinet can be used as a closet by placing the stowable seat in the stowed configuration.

17. The apparatus according to claim 16 wherein the stowable seat comprises a bench seat and a support, wherein the support supports the bench seat in use orientation such that a user may sit on the bench seat.

18. The apparatus according to claim 17 wherein the seat is generally L-shaped, with the bench seat forming one leg of the L-shape and the support forming the other leg of the L-shape.

19. The apparatus according to claim 17 wherein the bench seat is positioned against an interior wall of the cabinet in the stowed configuration.

20. The apparatus according to claim 17 wherein the stowable seat is removed from the interior of the cabinet in the stowed configuration.

21. The apparatus according to claim 1 and further comprising a plurality of stowable seats.

22. The apparatus according to claim 1 and further comprising a user interface operably coupled with the hear source for selectively controlling the supply of heat to the interior.

23. A recreational vehicle comprising an interior living space, comprising:
a cabinet located within the interior living space and defining an interior and having an opening providing access to the interior;
a heat source for selectively supplying heat to the interior;
a stowable seat operable between a use configuration, where a user can sit on the seat within the interior, and a stowed configuration; and
a hanging rod located within the interior;
whereby the apparatus can be converted from a closet to a sauna by removing items hanging on the hanging rod, placing the stowable seat in the use configuration, and selectively supplying heat to the interior with the heat source.

24. The recreational vehicle according to claim 23 wherein the hanging rod is mounted between opposing sides of the cabinet interior.

25. The recreational vehicle according to claim 24 wherein the hanging rod defines an internal raceway.

26. The recreational vehicle according to claim 25 further comprising an electrical conductor passing through the internal raceway.

27. The recreational vehicle according to claim 26 further comprising an electrical component associated with the cabinet and the electrical conductor is electrically coupled with the electrical component.

28. The recreational vehicle according to claim 27 further comprising at least two electrical components associated with the cabinet and the electrical conductor electrically couples the at least two electrical components.

29. The recreational vehicle according to claim 28 wherein the at least two electrical components are located on opposite sides of the cabinet.

30. The recreational vehicle according to claim 29 wherein the at least two electrical components are chosen from a group consisting of a controller, a heating element, a user interface, and a lamp.

31. The recreational vehicle according to claim 23, and further comprising a door mounted to the cabinet for movement between a closed position, where the door blocks human access from an exterior of the cabinet through the opening to the interior, and an open position, where human access is permitted from the exterior through the opening to the interior, and a vent permitting the flow of air between the interior and the exterior.

32. The recreational vehicle according to claim 31, wherein the vent comprises a gap between the door and the opening when the door is in the closed position to allow air to pass between the cabinet interior and the exterior of the cabinet.

33. The recreational vehicle according to claim 32 wherein at least a portion of the gap is directly open to the interior and the exterior.

34. The recreational vehicle according to claim 33 wherein the gap extends at least partially along a side of the door.

35. The recreational vehicle according to claim 34 wherein the gap extends at least partially along two sides of the door.

36. The recreational vehicle according to claim 35 wherein the gap extends substantially along all sides of the door.

37. The recreational vehicle according to claim 33 wherein the width of the gap is ⅛″.

38. The recreational vehicle according to claim 23 wherein the cabinet can be used as a closet by placing the stowable seat in the stowed configuration.

39. The recreational vehicle according to claim 38 wherein the stowable seat comprises a bench seat and a support, wherein the support supports the bench seat in use orientation such that a user may sit on the bench seat.

40. The recreational vehicle according to claim 39 wherein the seat is generally L-shaped, with the bench seat forming one leg of the L-shape and the support forming the other leg of the L-shape.

41. The recreational vehicle according to claim 40 wherein the bench seat is positioned against an interior wall of the cabinet in the stowed configuration.

42. The recreational vehicle according to claim 41 wherein the stowable seat is removed from the interior of the cabinet in the stowed configuration.

43. The recreational vehicle according to claim 23 and further comprising a plurality of stowable seats.

44. The apparatus according to claim 23 and further comprising a user interface operably coupled with the hear source for selectively controlling the supply of heat to the interior.

45. A storage apparatus for an interior living space, comprising:
a cabinet located within the interior living space and defining an interior and having an opening providing access to the interior;
an electrical component associated with the cabinet;
a hanging rod located within the interior and defining an internal raceway; and
an electrical conductor passing through the raceway and coupled to the electrical component.

46. The storage apparatus according to claim 45 wherein the hanging rod is extends between opposing sides of the cabinet interior.

47. The storage apparatus according to claim 45 wherein the electrical conductor is electrically coupled between at least two electrical components.

48. The storage apparatus according to claim 47 wherein the at least two electrical components are chosen from a group consisting of a controller, a heating element, a user interface, and a lamp.

49. The storage apparatus according to claim 45 wherein the hanging rod is configured to hold a clothes hanger and the cabinet interior is configured to store clothing on a clothes hanger such that the cabinet can be used as a closet.

50. The storage apparatus according to claim 49 wherein the cabinet comprises a heat source for selectively supplying heat to the interior.

51. The storage apparatus according to claim 50 and further comprising a stowable seat operable between a use configuration, where a user can sit on the seat within the interior, and a stowed configuration.

52. The storage apparatus according to claim 51 wherein the cabinet can be used as a closet by placing the stowable seat in the stowed configuration.

53. The storage apparatus according to claim 52 wherein the cabinet can be used as a sauna by removing any items hanging on the hanging rod, placing the stowable seat in the use configuration, and selectively supplying heat to the interior with the heat source.

54. A recreational vehicle comprising an interior living space, comprising:
a cabinet located within the interior living space and defining an interior and having an opening providing access to the interior;
an electrical component associated with the cabinet;
a hanging rod located within the interior and defining an internal raceway; and
an electrical conductor passing through the raceway and coupled to the electrical component.

55. The recreational vehicle according to claim 54 wherein the hanging rod is extends between opposing sides of the cabinet interior.

56. The recreational vehicle according to claim 54 wherein the electrical conductor is electrically coupled between at least two electrical components.

57. The recreational vehicle according to claim 56 wherein the at least two electrical components are chosen from a group consisting of a controller, a heating element, a user interface, and a lamp.

58. The recreational vehicle according to claim 54 wherein the hanging rod is configured to hold a clothes hanger and the cabinet interior is configured to store clothing on a clothes hanger such that the cabinet can be used as a closet.

59. The recreational vehicle according to claim 58 wherein the cabinet comprises a heat source for selectively supplying heat to the interior.

60. The recreational vehicle according to claim 59 and further comprising a stowable seat operable between a use configuration, where a user can sit on the seat within the interior, and a stowed configuration.

61. The recreational vehicle according to claim 60 wherein the cabinet can be used as a closet by placing the stowable seat in the stowed configuration.

62. The recreational vehicle according to claim 51 wherein the cabinet can be used as a sauna by removing any items hanging on the hanging rod, placing the stowable seat in the use configuration, and selectively supplying heat to the interior with the heat source.

63. A sauna, comprising:
a cabinet defining an interior and having an opening providing access to the interior;
a heat source for selectively supplying heat to the interior;
a door mounted to the cabinet and moveable between a closed position, where the door blocks human access from an exterior of the cabinet through the opening to the interior, and an open position, where human access is permitted from the exterior through the opening to the interior; and
a vent permitting the flow of air between the interior and the exterior and comprising a gap between the door and the opening when the door is in the closed position to allow air to pass between the cabinet interior and the exterior of the cabinet.

64. The sauna according to claim 63 wherein at least a portion of the gap is directly open to the interior and the exterior.

65. The sauna according to claim 63 wherein the gap extends at least partially along a side of the door.

66. The sauna according to claim 65 wherein the gap extends at least partially along two sides of the door.

67. The sauna according to claim 66 wherein the gap extends substantially along all sides of the door.

68. The sauna according to claim 63 wherein the gap has a width that effects the circulation of air between the cabinet interior and the exterior of the cabinet.

69. The sauna according to claim 68 wherein the width of the gap is ⅛″.

70. The sauna according to claim 63 and further comprising at least one seat.

71. The sauna according to claim 70 and further comprising a user interface operably coupled with the hear source for selectively controlling the supply of heat to the interior.

72. A method for operating a sauna cycle for a sauna comprising a cabinet defining an interior, a heat source for selectively supplying heat to the interior to maintain the interior temperature and a user interface operably coupled with the heat source for selectively controlling the operation of the heat source, the method comprising:
identifying a user from a group of users; and
operating the heat source in response to the identified user for at least one of a pre-determined cycle time associated with the identified user and maintaining the interior temperature at a pre-determined temperature associated with the identified user.

73. The method according to claim 72 wherein identifying the user comprises a user inputting a user identification.

74. The method according to claim 73 wherein inputting the user identification comprises the user selecting a user identification on the user interface.

75. The method according to claim 72 and further comprising operating the heat source in response to the identified user for the other of the pre-determined cycle time associated with the identified user and the maintaining the interior temperature at a pre-determined temperature associated with the identified user.

76. The method according to claim 75 wherein operating the heat source in response to the identified user comprises a user selecting a cycle time.

77. The method according to claim 76 wherein operating the heat source in response to the identified user comprises the user selecting a sauna temperature.

78. The method according to claim 77, and further comprising storing the cycle time and interior temperature selected by the user.

79. The method according to claim 78, and further comprising subsequently automatically setting the cycle time and interior temperature to the stored cycle time and interior temperature in response to the identified user.

80. The method according to claim 79 wherein identifying a user comprises a user inputting a user identification.

81. The method according to claim 80 wherein inputting a user identification comprises the user selecting a user identification on the user interface.
